(19) United States
(12) Patent Application Publication
(10) Pub. No.: US 2021/0304310 A1
(43) Pub. Date: Sep. 30, 2021

(54) SYSTEM AND METHOD FOR ESTIMATING MULTIFACTOR MODELS OF ILLIQUID, STALE AND NOISY FINANCIAL AND ECONOMIC DATA

(71) Applicant: Markov Processes International Inc., Summit, NJ (US)

(72) Inventors: Michael MARKOV, Short Hills, NJ (US); Apollon FRAGKISKOS, Charlotte, NC (US); Olga KRASOTKINA, Summit, NJ (US); Harold D. SPILKER, III, Honolulu, HI (US)

(21) Appl. No.: 17/301,051

(22) Filed: Mar. 23, 2021

Related U.S. Application Data
(60) Provisional application No. 63/001,022, filed on Mar. 27, 2020.

(51) Int. Cl. G06Q 40/06; G06N 20/00

(52) U.S. Cl. CPC G06Q 40/06; G06N 20/00

(57) ABSTRACT

A system and method for estimating factor exposures for an asset collection are described. The system includes a non-transitory memory arrangement storing data and a processor configured to perform operations including deriving input data including asset collection data and factor data including factors influencing the asset collection data. The operations further include defining parameters for an asset collection model, generating a lagged asset collection model, and generating a long horizon lagged asset collection model. The operations further include defining parameters for a factor exposure model, determining an objective function for the factor exposure model including an estimation error term between a long-horizon performance of the asset collection and a sum of products of each of the at least one factor exposure and respective long-horizon lag-aggregated factor performance, and estimating the factor exposures by optimizing a value of the objective function in the factor exposure model.

### PRIORITY CLAIM

The present application claims priority to U.S. Provisional Application Ser. No. 63/001,022 filed on Mar. 27, 2020, the entire disclosure of which is incorporated herewith by reference.

### FIELD

The present disclosure relates generally to computer systems and methods for estimating time-varying exposures for financial instruments using a multi-factor nonstationary model of dependency between financial time-series, an optimization approach for model estimation, and machine learning techniques for model validation when observed time series follows stale, nonstationary, autoregression process with low signal to noise ratio, heteroscedastic noise and noise serial correlations.

### BACKGROUND

Factor models, such as the multi-factor Capital Asset Prices Model (CAPM) and the Arbitrage Pricing Theory (APT), are well known in finance. These models of security prices consider many factors influencing securities returns and can be dynamic (time-varying) in general. The multi-factor CAPM and APT model parameters (e.g., factor exposures for an asset) are typically estimated by applying various linear regression techniques such as ordinary least squares (OLS) to the time series of security/portfolio returns and factors over a certain estimation window.

The quality of estimates of the model parameters are subject to the quality of the measurement and/or reporting of the input data, e.g., security and portfolio prices. It may be difficult to model certain assets, such as illiquid securities and private assets, to estimate their factor exposures when the input data includes relatively small sample sizes and/or a large number of factors influencing the asset return. The main problems for modeling illiquid investments include performance calculation issues/errors, staleness of net asset values (NAV) and return time-series data, heteroscedastic noise in data, a small number of observations to consider, and highly dynamic portfolios.

### SUMMARY

The present disclosure relates to a computer-implemented method for determining factor exposures for an asset collection including: (a) deriving input data including asset collection data and factor data for each time interval of a sequence of time intervals, wherein the factor data includes factors influencing the asset collection data; (b) defining parameters for an asset collection model including a factor set defined based on the factor data, lag parameters and long horizon parameters, the lag parameters including a kernel weight function and a kernel bandwidth for a lag aggregation of the factor data, the long horizon parameters including a kernel weight function and a kernel bandwidth for a long horizon aggregation of the asset data and the factor data; (c) generating a lagged asset collection model by applying the lag parameters to the factor data so that computed lagged factor data for each of the time intervals comprises a convolution of the factor data over multiple ones of the time intervals; (d) generating a long horizon lagged asset collection model by applying the long horizon parameters to the asset collection data and to the lagged factor data so that computed long horizon data comprises a convolution of the asset data and the lagged factor data over multiple ones of the time intervals; (e) defining parameters for a factor exposure model including a priori assumptions; (f) determining an objective function for the factor exposure model including an estimation error term between a long-horizon performance of the asset collection and a sum of products of each of the at least one factor exposure and respective long-horizon lag-aggregated factor performance; (g) estimating the factor exposures by optimizing a value of the objective function in the factor exposure model.

In an embodiment, the method further including implementing a cross validation method to determine a quality of the long horizon lagged asset collection model, the cross validation method comprising: (h) removing the asset collection data and factor data for one or more time intervals from the asset collection data and factor data; (i) performing steps (a)-(g) to estimate factor exposures for the removed time intervals; (j) predicting the removed asset collection data as a sum of products of the estimated factor exposures and the removed factor data; (k) repeating steps (h)-(j) for each time interval in the sequence of time intervals to produce a time series of predicted asset collection data; (l) generating a long horizon lagged predicted asset collection model by applying the long horizon parameters to the predicted asset collection data; and (m) calculating a value for the quality of the long horizon lagged asset collection model by comparing the long horizon lagged predicted asset collection model to the long horizon lagged asset collection model.

In an embodiment, the method further includes (n) defining a grid comprising a plurality of candidate model parameter sets; (o) performing steps (a)-(m) for each of the candidate model parameter sets in the grid to estimate the quality of the long horizon lagged asset collection model generated using each of the candidate model parameters sets; and (p) selecting an optimal model parameter set as the candidate model parameter set having an optimal quality metric.

In an embodiment, the objective function includes a term expressing prior information about the factor exposure model penalties, shrinkage or non-stationarity.

In an embodiment, the a priori assumptions for the factor exposure model consider the factor exposures to be time varying, the method further includes: defining a time volatility model for the factor exposures including parameters for a smoothness of the factor exposure model, a market changes parameter, and a scaling time-volatility parameter; including the time volatility model in the objective function as an a priori assumption; estimating the factor exposures as time varying; and performing steps (n)-(p) to select an optimal model parameter set for the time volatility model.

In an embodiment, the optimizing the value of the objective function in the factor exposure model is performed via a sliding window regression, dynamic programming, a Kalman filter-interpolator, or any other method of convex optimization.

In an embodiment, the value for the quality of the long horizon lagged asset collection model is an R-squared value, a mean squared error value, or a mean absolute error value.

In an embodiment, the method further includes (h) estimating values for the asset data using the estimated factor exposures and the lagged factor data; (i) calculating residuals between the asset data and the estimated asset data for each of the time intervals; (j) reshuffle the calculated residuals using block-wise picking up time points with a size of block equal to horizon; (k) excluding a factor from the asset collection model; (l) estimating values for the asset data at each time interval as a sum of product of the estimated factor exposures without a factor and the lagged factor data; (m) adding the reshuffled residuals to the estimated asset data; (n) estimating factor exposures for the excluded factor; (o) repeating (j)-(n) a number of times and collecting estimated factor exposure values for the excluded factor into a sample; (p) calculating a significance of a factor as a part of the collected sample that is less than the value for the excluded factor exposure; and (q) performing steps (j)-(p) for each of the factors.

In an embodiment, the optimizing the value of the objective function in the factor exposure model is performed via ordinary least squares (OLS), general least squares (GLS), or any other method of convex optimization.

In an embodiment, the defined parameters for the factor exposure model include factor exposure constraints, the constraints including one or more of non-negativity, bound constraints, or leverage amount constraints.

In an embodiment, the factors include financial and economic factors influencing a performance of the asset collection.

In an embodiment, the kernel weight function for the lag parameters or the long horizon parameters comprises a box kernel, a Gaussian kernel or an exponential kernel.

In an embodiment, the asset collection data includes a price of the asset collection, a Net Asset Value (NAV) of the asset collection, cash flows of the asset collection.

In an embodiment, the asset is an individual security including a private or public stock, bond, commodity, partnership or derivative instrument.

In an embodiment, the asset collection model is generated as lagged data from different markets.

In an embodiment, the asset collection is a hedge fund, mutual fund, private equity fund, venture capital fund or real estate fund.

In an embodiment, the asset collection data is a time series for a financial asset with a low signal to noise ratio, heteroscedastic noise and a high level of serial correlation.

In an embodiment, the method further includes using the estimated factor exposures to generate derived statistics for the asset collection.

In addition, the present disclosure relates to a system including a non-transitory memory arrangement storing data; and a processor configured to perform operations comprising: (a) deriving input data including asset collection data and factor data for each time interval of a sequence of time intervals, wherein the factor data includes factors influencing the asset collection data; (b) defining parameters for an asset collection model including a factor set defined based on the factor data, lag parameters and long horizon parameters, the lag parameters including a kernel weight function and a kernel bandwidth for a lag aggregation of the factor data, the long horizon parameters including a kernel weight function and a kernel bandwidth for a long horizon aggregation of the asset data and the factor data; (c) generating a lagged asset collection model by applying the lag parameters to the factor data so that computed lagged factor data for each of the time intervals comprises a convolution of the factor data over multiple ones of the time intervals; (d) generating a long horizon lagged asset collection model by applying the long horizon parameters to the asset collection data and to the lagged factor data so that computed long horizon data comprises a convolution of the asset data and the lagged factor data over multiple ones of the time intervals; (e) defining parameters for a factor exposure model including a priori assumptions; (f) determining an objective function for the factor exposure model including an estimation error term between a long-horizon performance of the asset collection and a sum of products of each of the at least one factor exposure and respective long-horizon lag-aggregated factor performance; and (g) estimating the factor exposures by optimizing a value of the objective function in the factor exposure model.

Furthermore, the present disclosure relates to a computer-implemented method for assessing a quality of a long horizon lagged asset collection model, including (a) deriving input data including asset collection data and factor data for each time interval of a sequence of time intervals, wherein the factor data includes factors influencing the asset collection data; (b) defining parameters for an asset collection model including a factor set defined based on the factor data, lag parameters and long horizon parameters; (c) generating a lagged asset collection model by applying the lag parameters to the factor data to compute lagged factor data for each of the time intervals; (d) generating a long horizon lagged asset collection model by applying the long horizon parameters to the asset collection data and to the lagged factor data to compute long horizon data; (e) defining parameters for a factor exposure model; (f) determining an objective function for the factor exposure model including an estimation error term; (g) estimating the factor exposures by optimizing a value of the objective function in the factor exposure model; and implementing a cross validation method to determine a quality of the long horizon lagged asset collection model, the cross validation method comprising: (h) removing the asset collection data and factor data for one or more time intervals from the asset collection data and factor data; (i) performing steps (a)-(g) to estimate factor exposures for the removed time intervals; (j) predicting the asset collection data as a sum of products of the estimated factor exposures and the removed factor data; (k) repeating steps (h)-(j) for each time interval in the sequence of time intervals to produce a time series of predicted asset collection data; (l) generating a long horizon lagged predicted asset collection model by applying the long horizon parameters to the predicted asset collection data; and (m) calculating a value for the quality of the long horizon lagged asset collection model by comparing the long horizon lagged predicted asset collection model to the long horizon lagged asset collection model.

### BRIEF DESCRIPTION OF THE DRAWINGS

FIG. 1 shows an exemplary embodiment of a system which generates a multi-factor model for an asset and computing derived statistics based on determined factor exposures.

FIG. 2 shows a method for generating a multi-factor model for an asset and computing derived statistics based on determined factor exposures.

FIG. 3 shows an exemplary graph for a lagged aggregation of factor returns for an asset relative to the current asset returns.

FIG. 4 shows an exemplary graph for a long horizon aggregation of fund returns.

FIG. 5 shows an exemplary diagram showing a cross-validation method.

### DETAILED DESCRIPTION

The present disclosure may be further understood with reference to the following description and the appended drawings, wherein like elements are referred to with the same reference numerals. The present invention relates to systems and methods for estimating time-varying factor exposures in financial or economic models. The exemplary embodiments describe a multi-factor dynamic optimization for model parameters while meeting constraints for the estimated time-varying factor exposures. In some embodiments, machine learning techniques are used for validating a quality of the model and extracting hidden factor exposures from limited, stale or noisy data.

Factor models, such as the multi-factor Capital Asset Prices Model (CAPM) and the Arbitrage Pricing Theory (APT), are well known in finance. These models of security prices consider many factors influencing securities returns and can be dynamic (time-varying) in general. Multi-factor CAPM can be represented by the following equation:

yₜ−rₜ^{ƒ}≅αₜ+Σᵢ₌₁ⁿβᵢ(x_{t,i}−rₜ^{ƒ}),t=1, . . . ,T, Equation (1)

where factor exposures or betas βᵢ, t=1, . . . , T, i=1, . . . , n and the intercept term αᵢ are model parameters to be estimated; yᵢ, t=1, . . . , T is the input time series of observed investment returns of a security or portfolio of securities, x_{t,i}, t=1, . . . , T, i=1, . . . , n are time series of returns of observed market indices or other factors, and rₜ^{ƒ}, t=1, . . . , T (optional) is a time series of returns of a risk-free instrument. Exposures βᵢ could be subject to various linear or non-linear constraints such as non-negativity.

In the APT model, the factors influencing securities returns may be major economic factors, such as industrial production, inflation, interest rates, business cycle, etc., or may be a set of asset classes or risk premia. The general APT model is typically written in the following form:

yₜ≅αₜ+Σᵢ₌₁ⁿβᵢx_{t,i},t=1, . . . ,T. Equation (2)

The multi-factor CAPM and APT model parameters are typically estimated by applying various linear regression techniques such as ordinary least squares (OLS) to the time series of security/portfolio returns and factors over a certain estimation window.

Challenges with Illiquid Securities and Private Assets

Some common examples of illiquid investments are thinly traded public stocks (e.g., penny stocks), certain types of bonds and debt, real estate, private companies and partnerships, and funds that invest in such instruments such as hedge funds, private real estate funds, and private equity funds. Some institutional separately managed accounts (SMA) portfolios and public mutual funds invest in illiquid securities and, therefore, analysis of their returns face similar challenges. While private equity funds are entirely invested in illiquid private assets, most hedge funds may have just a portion of their investments allocated to private debt or other illiquid investments. It is common practice for hedge funds to pool most of the illiquid securities into a so-called “side pocket,” primarily to streamline their accounting. The main problems for modeling illiquid investments include issues/errors with performance evaluation, staleness of net asset values (NAV) and return time-series data, heteroscedastic noise in data, a small number of observations to consider, and highly dynamic portfolios.

A first issue for performance evaluation is asynchronous pricing. One example of asynchronous pricing arises when securities are traded on world exchanges that operate in different time zones. Furthermore, portfolios that are invested in such global securities could in turn be valued in time zones different from some of the securities. As an example, a mutual fund sold in Japan that is investing in stocks listed in the U.S. will have its valuation based on the previous day's close prices in the U.S., resulting in a one-day shift. A model of such a fund using U.S. equities as factors may encounter a poor model fit. Lagged regressions are typically used to overcome such data issues, in which past periods are considered, but this may lead to a significant increase in the number of model variables. Lagged regressions may not work well in many cases where shifts in pricing periods represent a fraction of a period.

In another example, some mutual funds in Europe report their NAVs mid-day, while all of their securities and market factors are evaluated at market close. To deal with such a mismatch, input data is typically aggregated for the regression into weekly, monthly and quarterly, which usually improves results, but the resulting decrease in the number of observations lowers the quality of estimates. Particularly for a dynamic model, this may lead to loss of important information about the drift in factor exposures.

A second issue for performance evaluation is stale valuations and prices of both marketable and non-marketable assets. Valuations of non-marketable assets are based on, but not limited to, the price at which the investment was acquired, projected net earnings, earnings before interest, taxes, depreciation and amortization (“EBITDA”), the discounted cash flow method, public market or private transactions, local market conditions and trading values on public exchanges for comparable securities. Marketable securities that are very infrequently traded follow similar valuation processes. In the absence of an actively traded market of multiple market participants, valuations are performed infrequently (with a delay). The valuation parties typically use a significant degree of management judgment along with data that is not subject to frequent updates, such as projected earnings or comparable sales. As a result, most of the NAV data for private equity funds is subject to significant autocorrelation. The same holds true for illiquid marketable securities. For these reasons, valuations of private funds or funds that invest in illiquid securities may be stale and noisy, making regression analysis using market indices as factors very challenging.

A model for such a stale-price instrument (e.g., a private equity fund, an infrequently traded company or bond, etc.) is formulated below. Formally, it is assumed that true returns of a private equity fund, yᵢ, follow a linear multi-factor model with factor returns, x_{i,j}, with:

yₜ=αₜ+Σᵢ₌₁ⁿβ_{t,i}x_{t,i}+ξₜ=αₜ+βₜ^{T}xₜ+ξₜ,t=1, . . . ,T, Equation (3)

where ξᵢ are independent and identically distributed (i.i.d.) random errors, β_{t,i} is the time-varying sensitivity of the dependent variable to factor i, i=1, . . . ,n at moment t, t=1, . . . , T and αᵢ is the residual return unexplained by the model. However, true returns are not observable, and it is assumed that observed returns, yₜ⁰, are a function (stale reflection) of latent, “true,” returns that may include look-ahead bias as

yₜ⁰=ƒ(θ₀yₜ₊₁,θ₁yₜ, . . . ,θₖ₊₁yₜ₋ₖ)=Σₖ₌₀^{K}θₖyₜ₋ₖ₊₁ Equation (4)

where ƒ is a linear function that refers to a moving average process, K is the number of lags, and θₖ is the weighting on true returns yₜ₋ₖ₊₁, k=0, . . . , K. Equation (4) can also be thought of as an auto-regressive process whereby the fund's return depends upon current true returns and lagged observed fund returns. In this case, K would equal infinity and the weights would decay in a specified manner (in practice, valuations mainly depend upon a few recent lags and the weights to more distant lags to be either zero or very small, so as not to have a meaningful impact). Combining Equations (3) and (4) produces a data generating process where the dependent variable, yₜ⁰, depends on multiple lags of factors that drive return,

$${y}_{t}^{0} = {\sum }_{k = 0}^{K} {θ}_{k} ( {α}_{t - k + 1} + {β}_{t - k + 1}^{T} {x}_{t - k + 1} + {ξ}_{t} ) = {α}_{t}^{0} + {\sum }_{k = 0}^{K} {θ}_{k} ( {β}_{t - k + 1}^{T} {x}_{t - k + 1} + {ξ}_{t - k + 1} ) \qquad Equation ( 5 )$$

where αₜ⁰=Σₖ₌₀^{K}=θₖαₜ₋ₖ₊₁ is the excess return over factor returns from the joint estimations of θₖ, k=0, . . . , K and β_{t,i}, i=1, . . . , n, t=1, . . . , T.

Prices of illiquid stocks, structured products and certain debt instruments exhibit similar patterns of staleness and could be described by the model of Equation (5). This model is also applicable to a large number of hedge funds, especially the ones that invest in any of these assets.

A third issue for performance valuation is significant heteroskedastic noise. In many cases, securities and portfolios of securities have a very significant level of noise in their prices and returns that are not related to major market factors. One example is a market neutral investment strategy which involves buying and short-selling pairs of securities, or uses various hedging techniques in order to specifically minimize, if not eliminate, the effect of market factors on the daily movements of the portfolio. If such a strategy is successful in mitigating the impact of market factors, then such a portfolio's non-market security-specific risk would have a dominant effect on portfolio returns, and any regression model would have very low explanatory power with common market factors.

Another example is private equity (PE) and venture capital (VC) funds. For such funds, valuations of portfolio companies are not only stale, but also include subjective valuation biases, e.g., current quarter market environment could impact previous quarter valuations. Valuations are often subjective, and frequently valuations of the same private company differ between PE funds investing in the company. Valuation adjustments occur sporadically at exit or due to a market event, and private companies within the same fund portfolio could be valued at different time periods (asynchronously). Limited Partners (LP) receive private fund data from General Partners (GP) in the form of cash flows (inflows and distributions) and combined (“residual”) value of all investments in the fund. Cash flows could be also reported with a delay or skipped entirely. All of these issues contribute to significant noise in reported data and contribute to heteroscedastic noise in the model of Equation (5).

A fourth issue for performance evaluation is a small number of observations. It is noted that illiquidity in itself shrinks the data sample size, as the number of data points carrying information is smaller than for a frequently traded instrument. Aggregating data into less frequent weekly or monthly series helps to alleviate the problem somewhat. However, the situation is much worse when the data is reported very infrequently, as is the case with private assets. As an example, private equity funds are typically limited partnerships with a fixed term of 10 years which report data on quarterly basis. Although the life of such a fund could be longer, typically, the maximum number of data points for a typical private equity fund is about 40. In many cases, a factor model is required for a fund that has just several years of history. Aggregation of such quarterly data into, for example, annual data may produce too few observations to perform any factor modeling. The resulting decrease in the number of observations lowers the quality of estimates. For a dynamic portfolio especially, it could lead to loss of important information about the drift in factor exposures.

A fifth issue for performance evaluation is dynamic factor exposures. Factor exposures of private equity investments exhibit changes over time because portfolio companies undergo rapid changes through leverage, restructuring and M&A activity. Additionally, portfolio compositions may undergo rapid changes as new investments are made and past investments are sold. As valuations of the underlying companies change over time, GPs could change their reporting practices over time as well. Static factor models typically used in finance do not take into account the dynamic aspect of private equity factor exposures.

Multi-factor Model For Asynchronous, Stale and/or Noisy Market Data

The present disclosure relates to operations to apply multi-factor models to asynchronous (non-synchronous), serially correlated (stale) and noisy market data in finance and economics. The embodiments described herein allow for the estimation of multi-factor models even in the case of relatively small sample sizes and a large number of factors. Further, the embodiments described herein may consider possible model constraints and provide a way to calibrate model hyperparameters to recover hidden market exposures.

According to some aspects described herein, lags or lag aggregation is used for certain factors (e.g., prices, NAVs or returns of an asset) to mitigate modeling issues for instruments having asynchronous pricing information available. To be described in further detail below, lagged factor returns or aggregated lagged factor returns are used in the multi-factor model to take into account the dependence of observed return from preceding or delayed values of factors.

According to other aspects described herein, long-horizon (LH) aggregation is used for both the financial instrument and the lagged factors. For instruments with stale and noisy data, such as individual private equity funds, both of the aggregation levels (lagged and long horizon) may be used. Private equity fund data is extremely noisy when coupled with asynchronous cash flow and valuation data. The LH aggregation is intended to smooth out such noise and includes an overlapping rolling window of the same or varying lengths using equal or varying weights within the aggregation window, to be described further below.

Non-overlapping in long horizon aggregation may reduce the number of data points to a number that is not sufficient to estimate factor exposures in the multi-factor models. For example, ten years of monthly private equity fund data will have about 120 monthly data points, 40 quarterly data points, and only ten annual data points. Using annual non-overlapping data in such a case makes it impossible to estimate factor exposures when the number of factors is large and/or time-varying. To address this issue, the exemplary embodiments described herein use overlapping LH aggregation as opposed to non-overlapping LH aggregation. However, the use of overlapping LH raises several additional issues, as described below.

It is well-documented in statistics that the use of overlapping data causes serial correlation of observations. Thus, exposure estimates for the data may not be efficient. And while private equity return data is already serially correlated, adding overlapping aggregation further aggravates the issue. Long-horizon factor returns may behave like a random walk, and overlapping increases the correlation between both market factors themselves and investment portfolio performance data. The increased correlation between factors leads to unstable estimates of factor exposures. The spurious correlations between fund and factors performance time-series increases exposures so that the classical theory of inference may not be applicable. Factor exposures t-stats may be incorrect, and R-squared may increase with horizon.

Additionally, using a dynamic model instead of a static model increases the dimensionality of the problem N-fold, where N is the number of observations. For example, if there are 40 quarterly observations and a static factor model has 2 factors-variables, a dynamic model will have 80 variables to be estimated (two per each time period). In the presence of extremely high correlation between these two factors, caused by overlapping and lagging, the estimation of the dynamic factor model will be very unstable, as it fails to distinguish between highly correlated aggregated factor data.

There is extensive discussion about the effect of temporal aggregation in economics research. For example, in Rossana, R. J. and Seater, J. J., “Temporal aggregation and economic time series,” Journal of Business & Economic Statistics 13, 4 (1995), it is argued that aggregation loses information about the underlying data processes. It is noted that the averaging process changes the time series properties of the data at all frequencies, systematically eliminating some characteristics of the underlying data while introducing others, causing the aggregated data to have excessive long-term persistence. In another example, in Mamingi, N., “Beauty and ugliness of aggregation over time: A survey,” Review of Economics 68, 3 (2017), the issues of aggregation over time are summarized, including a lower precision of estimation and prediction, an aggregation bias in distributed lag models, and a generation of time series correlations under temporal aggregation. The benefits of aggregation are also mentioned, including that temporally aggregated data are less noisy than their disaggregated counterpart, aggregation over time does not affect the status of stationarity or non-stationarity of time series and the cointegratedness of variables is not affected. In still another example, in Jin, X., Wang, L., and Yu, J, “Temporal aggregation and risk-return relation,” Finance Research Letters 4, 2 (2007), the authors validate the reasonability of the usage of aggregation in analyzing risk-return linear relation, showing that the linear relation between risk and return will not be distorted by the temporal aggregation at all.

To address the seemingly unsolvable estimation issues described above and for estimation of the proper parameters values of the aggregated model, a good model quality measure is needed that is robust to overlapping and horizon. According to further aspects described herein, the generated multi-factor model (e.g., the double aggregation model described above) is analyzed (validated) via machine learning techniques such as cross-validation, marginal likelihood maximization, information criterion or bootstrap. Based on the result of the model analysis, the model parameters and hyperparameters may be optionally calibrated in order to improve the quality of the model. The model parameters, which may be significant, may be optimized by defining a grid of parameter values and applying various optimization algorithms to select the optimal parameter set in the grid.

Once a model is selected having an acceptable model quality or optimized model parameters, factor exposures or betas are computed and various statistics are derived using the computed factor exposures.

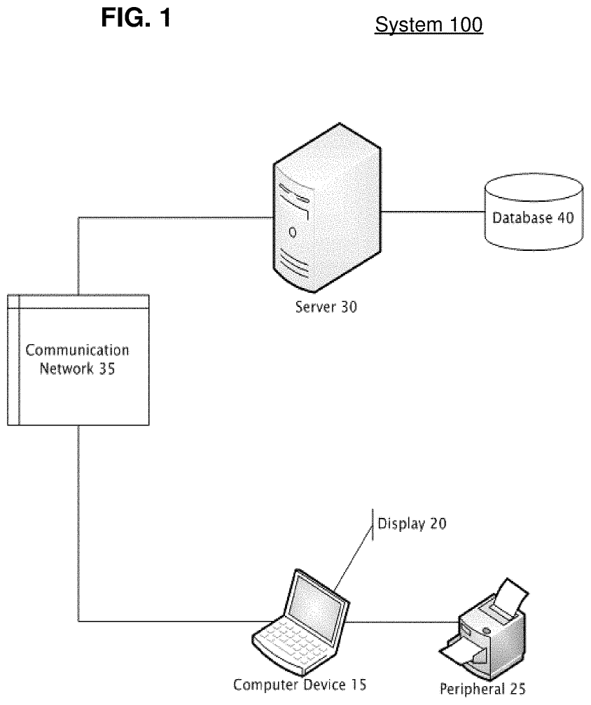

FIG. 1 shows an exemplary embodiment of a system 100 for generating a multi-factor model for an asset and computing derived statistics based on determined factor exposures. The system 100 may include a computer device 15 having a display 20, a memory arrangement (not pictured) and a processor (not pictured). The computer device 15 may be in communication with a peripheral device 25, as well as a communication network 35. The system 100 may further include a server 30 and a database 40, each in communication via the communication network 35.

As discussed above, the exemplary system 100 may utilize a lag aggregation and a long horizon aggregation to asynchronous, stale and/or noisy asset return data to generate a multi-factor model for the asset. Machine learning techniques such as cross validation, information criterion or bootstrap may be applied to optimize the parameters and/or factors used for the model, such that the system 100 may provide robust estimations for factor exposures for the asset and compute derived statistics for the asset based on the estimated exposures. Each of these aspects will be described in further detail below.

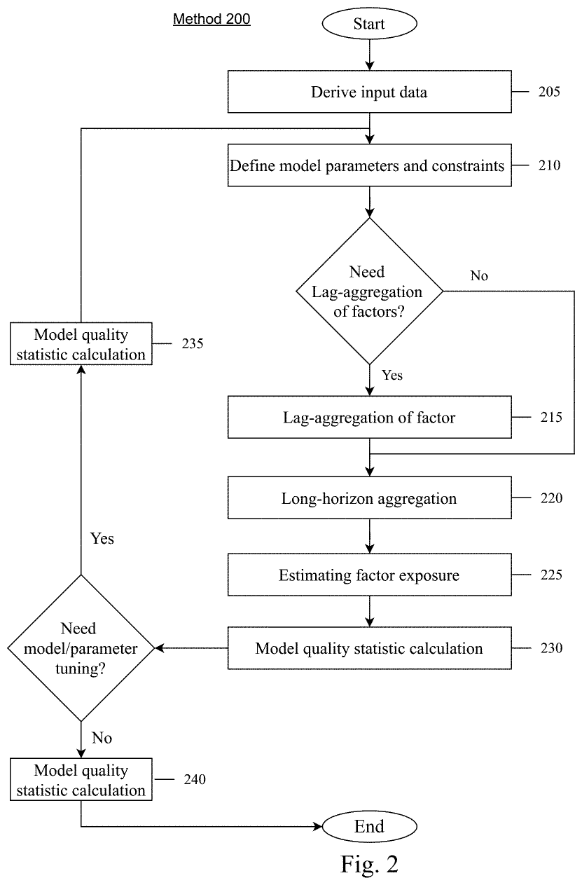

FIG. 2 shows a method 200 for generating a multi-factor model for an asset and computing derived statistics based on determined factor exposures. As discussed above, the asset may be an illiquid asset having asynchronous, stale and/or noisy return data, making conventional modeling difficult for determining factor exposures and analyzing the asset performance.

In 205, input data is derived for the model. The step 205 includes obtaining required input data for both: (a) assets (e.g., investments) to be analyzed (e.g., security, fund or portfolio) and (b) factors or model regressors such as market indices. For example, one or more S&P sectors may be used as market index factors. Other factors may include, for example, gross domestic product (GDP), employment, interest and inflation rates (macroeconomic factors), earnings, debt, market capitalization (fundamental factors), value, momentum, volatility, quality or other factors driving the return of a security.

The step 205 may further involve performing calculations for, e.g., prices, portfolio profit/loss (P&L) or fund NAVs for the observed data. For example, individual security prices, market indices or fund NAVs may be adjusted for distributions. For private equity funds, NAVs are calculated from called-in values, distributions and residual value to paid-in (RVPI). Substitutions may be made for missing observations. For example, for private equity funds, missing data could be estimated from data coming from multiple LPs investing in the asset. Further returns can be further calculated from NAVs and prices and, optionally, logarithmic or other transformations are applied.

In 210, model parameters and optional constraints are defined Defining the model parameters may include determining which factors to use in the model, as discussed above. Model parameters may further include the following, which will be described in further detail below: whether to use individual lags or aggregate lags, or no lags at all; lag depth (if any); weighting schema for lags; long-horizon depth and weighting schema; window size (if OLS regression or similar is used), Kalman Filter (KF) initial point, noise distributions and their parameters (if KF is used); state-space model parameters for a Dynamic Style Analysis model, etc.

Constraints on factor exposures are defined at this stage, including individual bands (non-negativity, upper-lower cap) and linear constraints, such as those described in U.S. Pat. No. 7,617,142, which is hereby incorporated by reference in its entirety. If lagged factors or lag-aggregation is used, then the method continues to 215, otherwise the method continues to 220.

In 215, lag-aggregation of factors is performed. Due to asynchronous pricing of financial instruments and/or valuation delays, returns of some instruments or portfolios of instruments (e.g., private equity (PE) funds) cannot be regressed against the returns of (non-stale) explanatory variables or factors, as this would produce biased estimates. To account for the dependence of observed return from preceding or delayed values of factors, lagged factor returns or an aggregation of each factor's lagged returns is used across time windows of certain length.

For example, for a single-factor factor model of a PE fund with quarterly NAV returns, a time-series of quarterly market index returns is used and, in addition, the same market index is lagged (shifted) by one, two or more quarters, thus creating a multi-factor model. Alternatively, single explanatory variables may be preserved by aggregating several lagged market index time series using equal weights or a certain weight function, such as exponential, to be described below. Such aggregation could be applied to prices, NAVs or returns.

In 220, long-horizon (LH) aggregation is performed for both the instrument and the defined factors. This second level of aggregation is performed to lessen the impact of heteroskedastic noise occurring, for example, in the valuation of illiquid assets. In step 220, both observed fund returns and factors are LH aggregated (the latter of which being first lag-aggregated, as described above in 215). Returns are aggregated over a long-horizon overlapping rolling window of the same or varying length using equal or varying weights within the aggregation window. For example, for a PE fund with quarterly data, returns of both the fund and each factor may be aggregated over the same overlapping four-quarter windows so that the returns are technically converted to overlapping annual intervals (annual horizon).

For stale and noisy data, as with individual private equity funds, both long-horizon aggregated and lag-aggregated observations may be used. By utilizing proper parameter calibration via cross-validation of the double-aggregation model, robust estimations of hidden factor exposures may be obtained through the time-varying regression estimation. The factors may be aggregated by, for example, simply calculating the compounded return or using a weighting schema that varies both within the aggregation window and also across time. Such aggregation could be applied to prices, NAVs or returns.

In 225, factor exposures or factor betas are estimated. Step 225 involves applying a model such as static linear regression (OLS, GLS or similar), rolling window regression, Kalman filter, DSA or any other regression estimation models given the parameters and constraints described above. The output of such a regression is a time series of factor exposures for each factor in the model.

In 230, model quality statistics are estimated. With overlapping-window long-horizon aggregation, as described above, typical regression inference statistics such as R-squared and associated tests such as F-squared may become biased. More robust techniques such as cross-validation (leave-one-out, jack knife, or similar), information criterions, maximum likelihood or bootstrap as typically used in machine learning, may be adopted to serially correlated observations to assess the quality of estimation, to be described in greater detail below.

Robust confidence intervals on factor betas may be computed as well. If, based on the model quality, it is determined that model parameters should be calibrated, the method continues to 235. Otherwise, the method continues to 240.

In optional 235, the model and parameters are redefined (e.g., calibrated). That is, the parameters defined in 210 are altered to improve the quality of the model computed and estimated at 230. Thus, in 235, the parameters are modified at 210 and steps 215-230 are repeated. If the new set of parameters produces an improvement in the model quality, then the factor exposures computed from the new set of parameters may be selected for use in following step 240. Since the number of parameters could be significant, a grid of parameter values may be defined, and various algorithms such as descent methods, binary search, and other optimization techniques may be deployed to select the optimal parameter set in the grid.

Factors selected for the analysis are part of the model and may be selected/calibrated at this step using calibration statistic improvement as the objective. Factor selection algorithms may be similar to the ones used in regressions, for example, forward selection, backward selection, brute force or stepwise, among others.

In 240, statistics are derived. Using the selected factor exposures, various statistics are calculated to assess and attribute performance for the analyzed asset. For example, internal rate of return (IRR) may be computed for private assets using Public Market Equivalent (PME) approaches, risk values such as Value-at-Risk (VaR) or conditional VaR (CVaR) may be computed, and Asset Allocation studies may be performed.

### Multi-Lag Aggregation

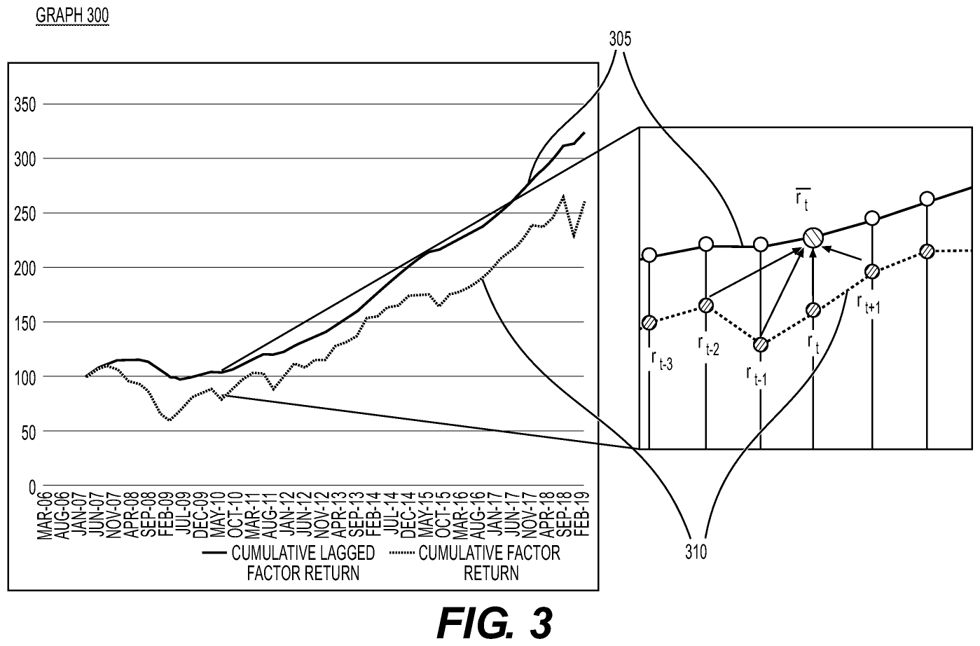

As mentioned above in step 215 of FIG. 2, a multi-lag aggregation approach may be used to overcome staleness in the securities data and recover true market beta. In a lagged (or forward) aggregation, the current stale asset return may be modeled as a function of several preceding, current and potential future market returns with a flexible weighting schema across lags. FIG. 3 shows an exemplary graph 300 for a lagged aggregation 305 of market factor returns for an asset relative to the current asset returns 310. The lagged return rₜ for each time point t of the exemplary lagged aggregation 305 is an aggregation of the current returns rₜ from time points (t−2), (t−1), (t) and (t+1). However, the lagged aggregation of graph 300 is only exemplary and different numbers of lags and weighting schemas may be used.

Formally, to address the staleness of data and/or asynchronous pricing, several lags of each factor are “collapsed” into a convolution of return time-series with a predefined weight function w(L), τ=1, . . . , T defining an aggregation of the factor returns across time. The particular lagging convolution function used for aggregation and/or a specific window under which factor returns are aggregated is not fixed. The lagging convolution function of returns to be used depends on the particular problem to be solved and the asset type, so the convolution function is generally defined on the whole time range:

r̅_{i,t}=w(t|L)*r_{i,t}=Σₛ₌₁^{T}r_{i,s}w(t−s|L),

where the weighting function is defined as:

$${\overline{r}}_{i , t} = w ( t \vert L ) * {r}_{i , t} = {\sum }_{s = 1}^{T} {r}_{i , s} w ( t - s \vert L )$$

where L is the kernel bandwidth, that can change between 0 and ∞.

Some examples of kernel functions for the convolution include:

box kernel:

K(x)={½, if |x|≤1,0,otherwise

Gaussian kernel:

$$K ( x ) = \frac{1}{\sqrt{2 π}} [ - \frac{{x}^{2}}{2} ] , ′$$

and
exponential kernel:

K(x)=[−|x|].

After the above transformation of factors, the stale asset (for example, a private equity fund) return yₜ⁰ could be viewed as a linear combination of aggregated lagged factor returns in a multi-factor model, as shown in Equation (6):

yₜ⁰=Σᵢ₌₁ⁿβᵢr̅_{i,t}+α+ξₜ, Equation (6)

where n is the number of factors, r̅_{t,i}=w(t)*r_{i,t}=Σₛ₌₁^{T} r_{i,s}w(t−s) is the aggregated lagged factor returns wherein T is the length of the entire data sample, βᵢ, i=1, . . . , n is the factor exposures and α is the intercept.

### Long-Horizon Overlapped Rolling Regression

To strengthen the signal coming from the observation data and to eliminate the noise in data, the observed fund returns are filtered through convolution and a long-horizon convolution function is applied to both sides of the multifactor model (6) as shown below:

$${\overline{y}}_{t}^{o} = v ( t \vert h ) * {y}_{t}^{o} = v ( t ) ( {\sum }_{i = 1}^{n} {β}_{i} {\overline{r}}_{i , t} + α ) = v ( t \vert h ) * [ {\sum }_{i = 1}^{n} {β}_{i} {\overline{r}}_{i , t} ] + v ( t \vert h ) * α = [ {\sum }_{i = 1}^{n} {β}_{i} v ( t \vert h ) * {\overline{r}}_{i , t} ] + v ( t1 h ) * α = [ {\sum }_{i = 1}^{n} {β}_{i} {\overline{\overline{r}}}_{i . t} ] + \overline{α} .$$

Due to properties of convolution, the convolution of fund returns leads to convolution of returns of the individual factors r̅_{i,t}=v(t|h)*r̅_{i,t}, α̅=v(h)*α, where r̅_{i,t} are long-horizon-aggregated and lag-aggregated factor returns. The weighting function is:

$$v ( τ \vert L ) = \frac{{K}^{L H} ( \frac{τ}{H} )}{{Σ}_{u = 1}^{T} {K}^{L H} ( \frac{u}{H} )}$$

with H being the kernel bandwidth. Some examples of long horizon kernel functions include:
box kernel:

K^{LH}(x)={½, if |x|≤1,0,otherwise,

Gaussian kernel:

$${K}^{L H} ( x ) = \frac{1}{\sqrt{2 π}} [ - \frac{{x}^{2}}{2} ] ′$$

and
exponential kernel:

K(x)=[−|x|].

The aggregated observed fund returns are then regressed on the set of similarly aggregated factor returns:

y̅ₜ⁰˜α̅+[Σᵢ₌₁ⁿβᵢr̅_{i,t}], Equation (7)

subject to properly selected constraints such as

s.t. l_{t,i}≤βᵢ≤h_{t,i}, s.t. l_{t,i}≤βᵢ≤h_{t,i} (individual bounds) and

s.t. l_{t,i}≤βᵢ≤h_{t,i}j=1, . . . ,m (general constraints)

where model parameters (α̅, β₁, . . . , βₙ) can be estimated using unconstrained and constrained least squares techniques:

(\hat{α̅},β₁, . . . ,βₙ)=argmin_{α̅,β}_{₁}_{, . . . ,β}_{ₙ}Σₜ₌₁^{N}(y̅ₜ⁰−α̅−Σᵢ₌₁ⁿβᵢr̅_{i,t})²,

subject to constraints

s.t. l_{t,i}≤βᵢ≤h_{t,i}, s.t. l_{t,i}≤βᵢ≤h_{t,i} (individual bounds) and

s.t. l_{t,i}≤βᵢ≤h_{t,i}j=1, . . . ,m (general constraints)

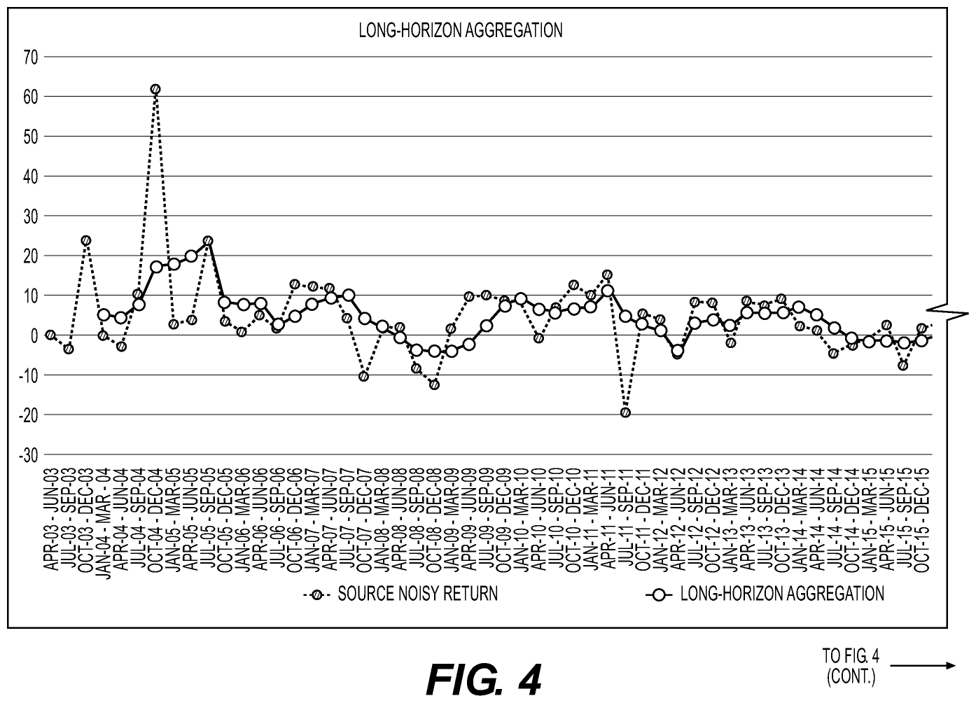

FIG. 4 shows an exemplary graph 400 for a long horizon aggregation 405 of market factor returns for an asset relative to the current asset returns 410. The current asset returns 410 may be noisy, as discussed above. The long horizon return for each time point t of the exemplary long horizon aggregation 405 is a convolution of the current returns from prior time points. However, the long horizon aggregation of graph 400 is only exemplary and different convolution parameters may be used.

### Dynamic Factor Exposures

Factor exposures typically change over time. The beta of private equity investments may display substantial time variation as the company is undergoing management, structural, debt structure and other changes through investments and M&A. Time variation in beta estimates for private equity funds could be driven by the fact that a fund comprises a portfolio of companies, which changes in composition over time. The exposures for a private equity fund can change depending on the age of the portfolio, companies bought or sold, and changes in valuation or leverage of the underlying companies. Further, GPs may change their reporting practices over time.

To obtain estimates of time-varying parameters, a series of window-based regressions is performed within sliding windows with a size smaller than data range T, or dynamic models are deployed such as a Kalman filter or a Dynamic Style Analysis

$$( \hat{\overline{α}} , {\hat{β}}_{1} , … , {\hat{β}}_{n} ) = {argmin}_{\hat{\overline{α}} , {\hat{β}}_{1} , … , {\hat{β}}_{n}} [ {\sum }_{t = 1}^{T} {( {\overline{y}}_{t}^{o} - {\overline{α}}_{t} - {β}_{t}^{T} {\overline{\overline{r}}}_{t} )}^{2} + {λ}_{0} {\sum }_{t = 2}^{T} {( {\overline{α}}_{t} - {\overline{α}}_{t - 1} )}^{2} + {λ}_{1} {\sum }_{t = 2}^{T} {( {β}_{t} - {V}_{t - 1} ( {β}_{t - 1} , {\overline{\overline{r}}}_{t - 1} ) {β}_{t - 1} )}^{T} {U}_{t} ( {β}_{t} - {V}_{t - 1} ( {β}_{t - 1} , {\overline{\overline{r}}}_{t - 1} ) {β}_{t - 1} ) \\ s . t . {l}_{t , i} \leq {β}_{i} \leq {h}_{t , i} , s . t . {l}_{t , i} \leq {β}_{i} \leq {h}_{t , i} ( individual bounds ) and \\ s . t . {l}_{t , i} \leq {β}_{i} \leq {h}_{t , i} j = 1 , … , m ( general constraints )$$

Further, a more general objective function could be used to estimate dynamic beta exposures to take into account possible cross correlation in error terms for overlapped data

$${min}_{{α}_{t} , {β}_{t} , t = 1 , … , T} [ {\sum }_{t = 1}^{T} {\sum }_{s = 1}^{T} {q}_{s , t} ( {\overline{y}}_{t}^{o} - {\overline{α}}_{t} - {β}_{t}^{T} {\overline{\overline{r}}}_{t} ) ( {\overline{y}}_{s}^{o} - {\overline{α}}_{s} - {β}_{s}^{T} {\overline{\overline{r}}}_{s} ) + B ( {β}_{t} , {α}_{t} = 1 , … , T \vert λ ) ] \qquad Equation ( 8 )$$

where B(βₜ, αₜ, t=1, . . . , T|λ) is the regularization term taking into account a priori information about factor exposure time changes, for example as in a state space model

$${β}_{t} = {\sum }_{m = 1}^{M} {V}_{t - m} {β}_{t - m} + {ξ}_{t}$$

where λ is the vector of state space model parameters and Q=[q_{t,s}, t=1, . . . , T, s=1, . . . , T] is the matrix of observation models parameters.

This regression problem in Equation (8) can then be solved using GLS, OLS with Newey-West corrections, maximum likelihood, Kalman filter interpolator or other techniques, depending on whether the betas are taken to be static or time varying, and whether the noise in Equation (7) is considered as i.i.d. or autocorrelated.

### Assessing Model Quality and Model Selection

The problem of estimating time-varying factor exposures from overlapping lagged observations inevitably concerns the need to choose the appropriate values of model hyperparameters including levels of model volatility and sizes of kernels bandwidths (number of lags and horizons).

In accordance with the specificity of the time-varying regression, the following exemplary embodiments describe methods for estimating hyperparameters in data models. According to some embodiments, modifications are made for data models including Cross Validation, Evidence Maximization and Information Criterion.

Cross validation is a statistical method for evaluation and comparison of learning methods. In particular, different values of hyperparameters are evaluated within the same method by dividing the data set into two segments. One data segment is used to train the model and the other data segment is used to validate it. Currently, cross-validation is widely accepted in data mining and machine learning applications, and serves as a standard procedure for performance estimation and model (hyperparameter) selection.

The basic form of cross-validation is k-fold cross-validation, in which the data is first partitioned into k equally sized segments or folds. Subsequently, k iterations of training and validation are performed such that, within each iteration, a different fold of the data is held out for validation while the remaining k−1 folds are used for learning. Leave-one-out cross validation (LOO) is a particular case of k-fold cross-validation, where k equals the number of instances in the data. In other words, nearly all the data except for a single observation are used in each iteration for training, and the model is tested on that single observation. An accuracy estimate obtained using LOO is known to be almost unbiased. If T is the size of the training set, the LOO test of model accuracy requires, in the general case, just runs of the training algorithm.

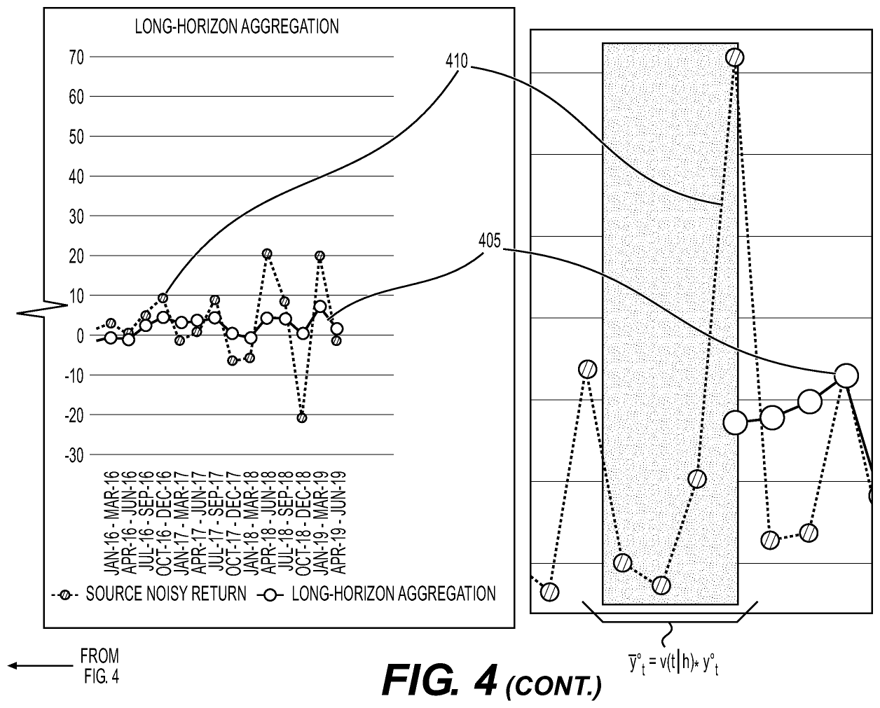

FIG. 5 shows an exemplary diagram 500 showing a cross-validation method. The method begins by assuming a starting value for parameters. The parameters may include the model parameters discussed above and model hyperparameters including, for example, levels of model volatility and sizes of kernels bandwidths (number of lags and horizons).

The method then begins with a training set of data for the asset and the parameters. The method then iteratively removes non-aggregated fund and factor return observations one at a time [(y₁⁰,r₁), . . . . , (yₜ₋₁⁰,rₜ₋₁), ? ?, (yₜ₊₁⁰,rₜ₊₁) . . . , (y_{T}⁰,r_{T})]. The method then prepares lagged and aggregated factors and fund returns series [(y̅₁⁰,r̅₁), . . . . , (y̅ₜ₋₁⁰,r̅ₜ₋₁), ? ?, (y̅ₜ₊₁⁰,r̅ₜ₊₁) . . . , (y̅_{T}⁰,r̅_{T})], based on chosen kernels, and estimates alpha and betas from aggregated data. Note that the alpha and beta estimated this way are unbiased estimators of the alpha and beta that corresponds to a regression without long horizons, but one where we can still have combined factors. We then use the derived alpha and beta corresponding to the missing point to calculate (i.e., predict) the removed instant fund return using the value of its corresponding leads and lags, as shown in 505 and 510. Repeating by removing each of the remaining fund and factor returns produces a time-series of predicted fund returns [ŷ₁⁰, . . . . , ŷₜ₋₁⁰, ŷₜ⁰, ŷₜ₊₁⁰ . . . , ŷ_{T}⁰], as shown in 515. The time-series of predicted fund returns is compared to the observed fund series to calculate an appropriate predicted value of an appropriate loss function Loss=L([yₜ⁰]ₜ₌₁^{T}, [ŷₜ⁰]ₜ₌₁^{T}), such as, for example, a mean square error:

$$M S E = \frac{{{Σ}_{t = 1}^{T} ( {y}_{t}^{o} - {\hat{y}}_{t}^{o} )}^{2}}{T}$$

or mean absolute error:

$$M A E = \frac{{Σ}_{t = 1}^{T} \vert {y}_{t}^{o} - {\hat{y}}_{t}^{o} \vert}{T}$$

or quality function such as Predicted R²:

$$P R 2 = 1 - \frac{{\sum }_{t = 1}^{T} {( {y}_{t}^{o} - {\hat{y}}_{t}^{o} )}^{2}}{{\sum }_{t = 1}^{T} {( {y}_{t}^{o} )}^{2}}$$

which is a measure of model fit similar to R², but which lacks the same in-sample bias. The comparison may be made not only for the regular observed returns but for the aggregated returns to reduce the unsystematic noise impact on loss Loss=L([y̅ₜ⁰]ₜ₌₁^{T}, [\hat{y̅}ₜ⁰]ₜ₌₁^{T}) or quality measure.

### Marginal Likelihood Maximization

The principle of marginal likelihood maximization allows for finding an appropriate combination of hyperparameters through an iterative procedure. Let the sequence of factor returns r=(rₜ, t=1, . . . , T) to be fixed. If

$$Φ ( r , l , h , Q ) = \frac{1}{\vert Q \vert {( 2 π )}^{\frac{T}{2}}} \{ - \frac{1}{2} {( {\overline{y}}^{0} \overline{\overline{R}} β )}^{T} {Q}^{- 1} ( {\overline{y}}^{0} - \overline{\overline{R}} β ) \}$$

is the parametric family of conditional probability densities over all the feasible realizations of the portfolio return, and

$$Ψ ( λ ) = \frac{1}{{\vert B ( λ ) \vert}^{\frac{1}{2}} {( 2 π )}^{\frac{T n}{2}}} \{ - \frac{1}{2} {β}^{T} B ( λ ) β \}$$

is the assumed parametric family of a priori densities over all the possible sequences of factor exposures vectors, then the continuous mixture

F(y̅⁰|r,λ,l,h,Q)=∫_{Rn}Φ(y̅⁰|r,l,h,Q)Ψ(β|λ)dβ

has the sense of the likelihood function over the range of hyperparameter combinations r, λ, l, h, Q. This function is frequently referred to as Marginal Likelihood or Evidence. Maximization of the marginal likelihood, which is completely defined by the given data set, is one way of choosing appropriate values of hyperparameters:

\hat{λ},\hat{l},ĥ,\hat{Q}=argmax_{λ,l,h,Q}{F(r,λ,l,h,Q)}

Marginal Likelihood may be particularly useful in the case of time-varying regression, since both mixed and mixing distributions are normal.

### Information Criterion

The main idea underlying the information criterion is the view of the maximum point of Kulback similarity between the model and universe:

\hat{λ},\hat{l},ĥ,\hat{Q}=argmax_{λ,l,h,Q}∫{ln ln Φ(y̅⁰|β*(λ,l,h,Q),r)Φ(y̅⁰)}dy̅⁰

The Bayesian Information Criterion (BIC) is a popular modification of the principle. For continuous hyperparameters estimation in time-varying models the generalization of information criterion is as follows:

\hat{λ},\hat{l},ĥ,\hat{Q}=argmax_{λ,l,h,Q}{−½(y̅⁰−R̅β)^{T}Q⁻¹(y̅⁰−R̅β)+Tr[R̅R̅^{T}(R̅R̅^{T}+B(λ))⁻¹]}

### Bootstrap for Factor Significance Calculation

Bootstrapping is a statistical method including performing random sampling a number of times, e.g., 1000 times, to generate simulated samples and estimate parameters for a data set. Residuals are calculated without aggregation using the initial non-aggregated fund return, with lags applied to factors. The factors are reshuffled using block-wise picking up to four time points simultaneously. For factor t-stat distribution, the beta for the testing factor is set as 0 (the hypothesis beta=0 is checked), alpha=0, and the estimated betas for other factors, lagged factors and reshuffled residuals are used to create the bootstrapped version of fund return. For alpha t-stat distribution, the alpha is set as 0 and the estimated beta, lagged factor and reshuffled residuals are used to create the bootstrapped fund return. A horizon aggregation is then applied for the bootstrapped version of the fund return and 25 points are received.

The beta or alpha is estimated for omitted factor or alpha along with others factors, with lags and horizon applied to the factor returns series. This process is performed for the number of simulations, e.g., 1000 times, and the betas (betas t-stats) estimate are collected into a null-hypothesis distribution. The p-val is estimated for the testing factor or alpha according to the distribution.

### Computation of Derived Statistics

With factor exposures estimated using the approach described above, a number of important statistics may be calculated using factor betas and original (not aggregated) factor returns such as: estimated beta factor portfolio returns yₜ=Σᵢ₌₁ⁿ \hat{β}ₜⁱrₜⁱ, t=1, . . . , T where rₜⁱ is original input factor returns (not lagged and not aggregated) and \hat{β}ₜ^{t} is corresponding estimated factor exposures; such return representing performance of the liquid and systematic equivalent of the analyzed illiquid investment (fund or security); performance attribution to factors: \hat{β}ₜⁱrₜⁱ, i=1, . . . , n, t=1, . . . , T, risk such as component risk, VaR, CVaR; Internal rate of return (IRR) using beta factor portfolio as the market index in Public Market Equivalent (PME) methodologies for private equity funds such as Long-Nickels PME, PME+, Kaplan Schoar PME and others.

The present invention has been described with reference to specific exemplary embodiments thereof. It will, however, be evident that various modifications and changes may be made thereto without departing from the broadest spirit and scope of the present invention as set forth in the disclosure herein. Accordingly, the specification and drawings are to be regarded in an illustrative rather than restrictive sense.

1. A computer-implemented method for determining factor exposures for an asset collection, comprising:
(a) deriving input data including asset collection data and factor data for each time interval of a sequence of time intervals, wherein the factor data includes factors influencing the asset collection data;
(b) defining parameters for an asset collection model including a factor set defined based on the factor data, lag parameters and long horizon parameters, the lag parameters including a kernel weight function and a kernel bandwidth for a lag aggregation of the factor data, the long horizon parameters including a kernel weight function and a kernel bandwidth for a long horizon aggregation of the asset data and the factor data;
(c) generating a lagged asset collection model by applying the lag parameters to the factor data so that computed lagged factor data for each of the time intervals comprises a convolution of the factor data over multiple ones of the time intervals;
(d) generating a long horizon lagged asset collection model by applying the long horizon parameters to the asset collection data and to the lagged factor data so that computed long horizon data comprises a convolution of the asset data and the lagged factor data over multiple ones of the time intervals;
(e) defining parameters for a factor exposure model including a priori assumptions;
(f) determining an objective function for the factor exposure model including an estimation error term between a long-horizon performance of the asset collection and a sum of products of each of the at least one factor exposure and respective long-horizon lag-aggregated factor performance;
(g) estimating the factor exposures by optimizing a value of the objective function in the factor exposure model.

2. The method of claim 1, further comprising:
implementing a cross validation method to determine a quality of the long horizon lagged asset collection model, the cross validation method comprising:
(h) removing the asset collection data and factor data for one or more time intervals from the asset collection data and factor data;
(i) performing steps (a)-(g) to estimate factor exposures for the removed time intervals;
(j) predicting the removed asset collection data as a sum of products of the estimated factor exposures and the removed factor data;
(k) repeating steps (h)-(j) for each time interval in the sequence of time intervals to produce a time series of predicted asset collection data;
(l) generating a long horizon lagged predicted asset collection model by applying the long horizon parameters to the predicted asset collection data; and
(m) calculating a value for the quality of the long horizon lagged asset collection model by comparing the long horizon lagged predicted asset collection model to the long horizon lagged asset collection model.

3. The method of claim 2, further comprising:
(n) defining a grid comprising a plurality of candidate model parameter sets;
(o) performing steps (a)-(m) for each of the candidate model parameter sets in the grid to estimate the quality of the long horizon lagged asset collection model generated using each of the candidate model parameters sets; and
(p) selecting an optimal model parameter set as the candidate model parameter set having an optimal quality metric.

4. The method of claim 3, wherein the objective function includes a term expressing prior information about the factor exposure model penalties, shrinkage or non-stationarity.

5. The method of claim 4, wherein the a priori assumptions for the factor exposure model consider the factor exposures to be time varying, the method further comprising:
defining a time volatility model for the factor exposures including parameters for a smoothness of the factor exposure model, a market changes parameter, and a scaling time-volatility parameter;
including the time volatility model in the objective function as an a priori assumption;
estimating the factor exposures as time varying; and
performing steps (n)-(p) to select an optimal model parameter set for the time volatility model.

6. The method of claim 5, wherein optimizing the value of the objective function in the factor exposure model is performed via a sliding window regression, dynamic programming, a Kalman filter-interpolator, or any other method of convex optimization.

7. The method of claim 2, wherein the value for the quality of the long horizon lagged asset collection model is an R-squared value, a mean squared error value, or a mean absolute error value.

8. The method of claim 1, further comprising:
(h) estimating values for the asset data using the estimated factor exposures and the lagged factor data;
(i) calculating residuals between the asset data and the estimated asset data for each of the time intervals;
(j) reshuffle the calculated residuals using block-wise picking up time points with a size of block equal to horizon;
(k) excluding a factor from the asset collection model;
(l) estimating values for the asset data at each time interval as a sum of product of the estimated factor exposures without a factor and the lagged factor data;
(m) adding the reshuffled residuals to the estimated asset data;
(n) estimating factor exposures for the excluded factor;
(o) repeating (j)-(n) a number of times and collecting estimated factor exposure values for the excluded factor into a sample;
(p) calculating a significance of a factor as a part of the collected sample that is less than the value for the excluded factor exposure; and
(q) performing steps (j)-(p) for each of the factors.

9. The method of claim 1, wherein optimizing the value of the objective function in the factor exposure model is performed via ordinary least squares (OLS), general least squares (GLS), or any other method of convex optimization.

10. The method of claim 1, wherein the defined parameters for the factor exposure model include factor exposure constraints, the constraints including one or more of non-negativity, bound constraints, or leverage amount constraints.

11. The method of claim 1, wherein the factors include financial and economic factors influencing a performance of the asset collection.

12. The method of claim 1, wherein the kernel weight function for the lag parameters or the long horizon parameters comprises a box kernel, a Gaussian kernel or an exponential kernel.

13. The method of claim 1, wherein the asset collection data includes a price of the asset collection, a Net Asset Value (NAV) of the asset collection, cash flows of the asset collection.

14. The method of claim 1, wherein the asset is an individual security including a private or public stock, bond, commodity, partnership or derivative instrument.

15. The method of claim 1, wherein the asset collection model is generated as lagged data from different markets.

16. The method of claim 1, wherein the asset collection is a hedge fund, mutual fund, private equity fund, venture capital fund or real estate fund.

17. The method of claim 1, wherein the asset collection data is a time series for a financial asset with a low signal to noise ratio, heteroscedastic noise and a high level of serial correlation.

18. The method of claim 1, further comprising:
using the estimated factor exposures to generate derived statistics for the asset collection.

19. A system, comprising:
a non-transitory memory arrangement storing data; and
a processor configured to perform operations comprising:
(a) deriving input data including asset collection data and factor data for each time interval of a sequence of time intervals, wherein the factor data includes factors influencing the asset collection data;
(b) defining parameters for an asset collection model including a factor set defined based on the factor data, lag parameters and long horizon parameters, the lag parameters including a kernel weight function and a kernel bandwidth for a lag aggregation of the factor data, the long horizon parameters including a kernel weight function and a kernel bandwidth for a long horizon aggregation of the asset data and the factor data;
(c) generating a lagged asset collection model by applying the lag parameters to the factor data so that computed lagged factor data for each of the time intervals comprises a convolution of the factor data over multiple ones of the time intervals;
(d) generating a long horizon lagged asset collection model by applying the long horizon parameters to the asset collection data and to the lagged factor data so that computed long horizon data comprises a convolution of the asset data and the lagged factor data over multiple ones of the time intervals;
(e) defining parameters for a factor exposure model including a priori assumptions;
(f) determining an objective function for the factor exposure model including an estimation error term between a long-horizon performance of the asset collection and a sum of products of each of the at least one factor exposure and respective long-horizon lag-aggregated factor performance; and
(g) estimating the factor exposures by optimizing a value of the objective function in the factor exposure model.

20. A computer-implemented method for assessing a quality of a long horizon lagged asset collection model, comprising:
(a) deriving input data including asset collection data and factor data for each time interval of a sequence of time intervals, wherein the factor data includes factors influencing the asset collection data;
(b) defining parameters for an asset collection model including a factor set defined based on the factor data, lag parameters and long horizon parameters;
(c) generating a lagged asset collection model by applying the lag parameters to the factor data to compute lagged factor data for each of the time intervals;
(d) generating a long horizon lagged asset collection model by applying the long horizon parameters to the asset collection data and to the lagged factor data to compute long horizon data;
(e) defining parameters for a factor exposure model;
(f) determining an objective function for the factor exposure model including an estimation error term;
(g) estimating the factor exposures by optimizing a value of the objective function in the factor exposure model; and
implementing a cross validation method to determine a quality of the long horizon lagged asset collection model, the cross validation method comprising:
(h) removing the asset collection data and factor data for one or more time intervals from the asset collection data and factor data;
(i) performing steps (a)-(g) to estimate factor exposures for the removed time intervals;
(j) predicting the asset collection data as a sum of products of the estimated factor exposures and the removed factor data;
(k) repeating steps (h)-(j) for each time interval in the sequence of time intervals to produce a time series of predicted asset collection data;
(l) generating a long horizon lagged predicted asset collection model by applying the long horizon parameters to the predicted asset collection data; and
(m) calculating a value for the quality of the long horizon lagged asset collection model by comparing the long horizon lagged predicted asset collection model to the long horizon lagged asset collection model.
